(19) United States
(12) Patent Application Publication
(10) Pub. No.: US 2026/0135109 A1
(43) Pub. Date: May 14, 2026

(54) ELECTRODE MATERIAL LAYER COMPOSITION COMPRISING BINDER FOR DRY PROCESS AND LITHIUM ION BATTERY COMPRISING SAME

(71) Applicants: JONG EUN KIM, Seoul (KR); CNP SOLUTIONS CO., LTD., Seoul (KR)

(72) Inventors: JONG EUN KIM, Seoul (KR); BO WON SUH, Gyeonggi-do (KR); KWANG SUCK SUH, Gyeonggi-do (KR); JONG HO PARK, Chungcheongnam-do (KR)

(21) Appl. No.: 19/118,070

(22) PCT Filed: Oct. 5, 2023
(86) PCT No.: PCT/KR2023/015302

§ 371 Date: Apr. 3, 2025

(30) Foreign Application Priority Data
Oct. 5, 2022 (KR) 10-2022-0127133
Feb. 3, 2023 (KR) 10-2023-0014776

(51) Int. Cl. H01M 4/62; H01M 4/04; H01M 10/0525

(52) U.S. Cl. CPC H01M 4/622; H01M 4/0404; H01M 4/0435; H01M 10/0525

(57) ABSTRACT

An electrode material layer composition includes a positive or negative electrode active material, an acrylate-based compound as a binder, and a curing agent for the acrylate-based compound. In a method of manufacturing a lithium-ion battery electrode, the electrode material layer composition is prepared, a positive electrode material layer sheet or a negative electrode material layer sheet is formed using the electrode material layer composition, the positive electrode material layer sheet or the negative electrode material layer sheet is attached to a metal electrode plate, the attached positive electrode material layer sheet or negative electrode material layer sheet is cured to obtain an electrode, and the electrode material layer obtained by performing the curing is rolled.

### BACKGROUND

### 1. Technical Field

The present disclosure is a technology relating to a lithium-ion battery electrode. More specifically, the present disclosure relates to an electrode material layer composition including a novel binder for a dry process, an electrode including the composition, a method of manufacturing the electrode, and a lithium-ion battery including the electrode, wherein the novel binder not only can solve problems that, since existing binders used when manufacturing electrodes by a dry process, rather than by a wet process, are solid particles, particle agglomeration occurs due to static electricity generated by the friction between the solid particles during kneading, hindering uniform kneading, but also enables the fabrication of a sheet having a thickness of smaller than 100 microns even at relatively low pressure when manufacturing an electrode material layer sheet.

### 2. Background Art

Lithium-ion batteries are fabricated by mixing lithium-containing compound particles serving as positive electrode (cathode) active materials and negative electrode (anode) active materials represented as graphite in conjunction with a binder to form an active material layer on a metal foil (electrode plate) made of aluminum, copper, or the like, introducing an electrolyte thereinto, and then placing a separation membrane, which is called a separator, in the middle for lamination. In this case, such a lithium-ion battery operates through repeated processes in which lithium ions enter and exit a positive electrode active material layer and a negative electrode active material layer (lithiation and de-lithiation).

The existing technology to fabricate electrode plates involves dispersing an active material, a binder, other additives, and the like in a solvent to prepare what is called a slurry, applying the slurry onto a metal electrode plate to a predetermined thickness, and then drying the resulting product to form an active material electrode plate, which is called a wet method. This method, which has been used for a long time, enables individual components to be uniformly mixed and thus can maximize battery performance, which is advantageous. However, in the drying process, the solvent must be eliminated. In addition, this method is extremely inconvenient in both economic and environmental aspects due to the difficulty of recovering all solvents that pose a risk of causing air pollution.

A technology that has been recently disclosed to address such problems is a dry process. This dry process is a technique to manufacture an electrode plate by mixing active materials and other additives in conjunction with a binder as it is in a dry manner without any solvent, then applying pressure thereto to fabricate an active material composition sheet, and attaching the resulting active material composition sheet onto a metal electrode plate. In such a dry method, complex solvent removal and trapping processes are omittable, so solvent recovery devices are unnecessary. In other words, the dry method is much more eco-friendly than the existing wet method.

However, when manufacturing electrode plates by dry processes, active materials, binders, and additives (represented as conductive carbon black or carbon nanotubes) must be dispersed in a dry manner. In this case, selecting appropriate binders can be considered crucial in dry processes, as predetermined materials are used as active materials and conductivity enhancers. While all existing binders used in dry processes are solid particles, each of the particles differs in size and density. In particular, when kneading individual components, the friction between solid particles causes electric charges to be generated on the surface, and the resulting static electricity causes particle agglomeration, hindering uniform kneading and causing problems that uniform kneading is challenging.

Therefore, there is an urgent need for the development of a novel binding technology that enables individual components, such as active materials, conductivity enhancers, and the like, to be even further uniformly kneaded even in a dry process not involving the use of any solvent, in other words, a novel binder material having properties suitable for use in dry processes and an electrode material layer composition including the same.

### SUMMARY

Accordingly, one objective of the present disclosure lies in providing a new use of an acrylate-based compound that is liquid at room temperature and is post-curable and, in other words, is to provide an electrode material layer composition including an acrylate-based compound as a novel binder to solve problems that, since existing binders used when manufacturing electrodes by a dry process not involving the use of any solvent are solid particles, particle agglomeration occurs due to static electricity generated by the friction between the solid particles during kneading, hindering uniform kneading.

Another objective of the present disclosure is to provide a method of manufacturing an electrode, wherein an acrylate-based compound, serving as a novel binder for a dry process, enables the use of a uniformly kneaded electrode material layer composition, so a thinner positive electrode material layer or negative electrode material layer can be manufactured at low pressure, such a manufactured positive electrode material layer sheet or negative electrode material layer sheet is attached to an electrode plate and then is enabled to be well-attached to the electrode plate through post-curing of the acrylate-based compound included in the sheet, and an additional rolling process is performed, as needed, to enable the sheet to be even further firmly attached to the surface of the electrode plate, and an electrode manufactured thereby.

A further objective of the present disclosure is to provide a lithium-ion battery that not only can be highly eco-friendly and economical by including an electrode manufactured by a dry process and thus omitting complex solvent removal and trapping processes but also is downsizable due to a thinner positive electrode material layer or negative electrode material layer.

Objectives of the present disclosure are not limited to the objectives mentioned hereinabove, and other objectives not mentioned will be clearly understood by those skilled in the art from the following description.

To achieve the aforementioned objectives of the present disclosure, the present disclosure first provides an electrode material layer composition for a dry process, the electrode material layer composition including a positive or negative electrode active material, an acrylate-based compound, and a curing agent for the acrylate-based compound.

In one preferred embodiment, the acrylate-based compound includes a methacrylate-based compound.

In one preferred embodiment, the acrylate-based compound contains 2 to 16 functional groups and is a monomer or oligomer whose main chain has 2 to 1,000 carbon atoms.

In one preferred embodiment, the functional group ranges from 2 to 16 in number and is one or more selected from the group consisting of methylene, a urethane group, an ester group, an ether group, an oxide group, ethyleneoxide group, a propyleneoxide group, an ethyleneglycol group, a propyleneglycol group, a butadiene group, an imide group, an amine group, an amide group, an epoxy group, an olefin group, a sulfone group, and a combination thereof.

In one preferred embodiment, the acrylate-based compound is included in an amount range of 0.1 to 20 parts by weight per 100 parts by weight of the positive or negative electrode active material.

In one preferred embodiment, the curing agent is one or more of a heat-curing agent and a photocuring agent and is included in an amount range of 0.1 to 20 parts by weight per 100 parts by weight of the acrylate-based compound.

In one preferred embodiment, the heat-curing agent includes a peroxide or an azo compound, and the photocuring agent includes a phenylketone-based compound or a phosphineoxide-based compound.

In one preferred embodiment, one or more binders that differ from the acrylate-based compound in type are further included.

In one preferred embodiment, the acrylate-based compound and the binder have a weight ratio in the range of 99:1 to 1:99.

In one preferred embodiment, one or more nanocarbon-based conductivity enhancers composed of conductive carbon black, graphene, and carbon nanotubes are further included.

In one preferred embodiment, the positive or negative electrode active material includes one or more selected from the group consisting of lithium, manganese, nickel, cobalt, aluminum, iron, phosphorus, tin, titanium, a carbon material, silicon, silicon oxide, sulfur, and a combination thereof.

In addition, the present disclosure provides a lithium-ion battery electrode including a positive electrode material layer or a negative electrode material layer made of any one of the aforementioned electrode material layer compositions for the dry process.

Furthermore, the present disclosure provides a method of manufacturing a lithium-ion battery electrode, the method including: a composition preparation step of preparing any one of the aforementioned electrode material layer compositions for the dry process; a sheet formation step of forming a positive electrode material layer sheet or a negative electrode material layer sheet using the electrode material layer composition for the dry process; an attachment step of attaching the positive electrode material layer sheet or the negative electrode material layer sheet to a metal electrode plate; a curing step of curing the attached positive electrode material layer sheet or negative electrode material layer sheet to obtain an electrode; and a step of rolling the electrode material layer obtained by performing the curing step.

In one preferred embodiment, the attachment step performed includes: a step of forming a primer layer on the metal electrode plate; and a step of placing and compressing the positive electrode material layer sheet or the negative electrode material layer sheet onto the primer layer.

In one preferred embodiment, the curing step is performed by one or more of photocuring through ultraviolet (UV) irradiation and heat curing to treat the attached positive electrode material layer sheet or negative electrode material layer sheet for 5 minutes to 30 minutes at a temperature in the range of 50° C. to 180° C.

Furthermore, the present disclosure provides a lithium-ion battery including the aforementioned lithium-ion battery electrode.

Furthermore, the present disclosure provides a lithium-ion battery including a lithium-ion battery electrode manufactured by the aforementioned method.

According to the aforementioned electrode material layer composition of the present disclosure, an acrylate-based compound that is liquid at room temperature is included as a binder, so active materials can be even further uniformly kneaded without causing problems that, since existing binders used when manufacturing electrodes by a dry process not involving the use of any solvent are solid particles, particle agglomeration occurs due to static electricity generated by the friction between the solid particles during kneading, thus hindering uniform kneading.

In addition, according to a lithium-ion battery electrode of the present disclosure and a method of manufacturing the electrode, the acrylate-based compound enables the use of a uniformly kneaded electrode material layer composition, so a thinner positive electrode material layer or negative electrode material layer can be manufactured at low pressure. After such a manufactured positive electrode material layer sheet or negative electrode material layer sheet is attached to an electrode plate, the acrylate not only is solidified through post-curing of the acrylate-based compound included in the sheet to play a binder role but also enables the sheet to be well-attached to the electrode plate, and a rolling process can be performed to increase the electrode density.

Furthermore, according to a lithium-ion battery of the present disclosure, the lithium-ion battery not only can be highly eco-friendly and economical by including an electrode manufactured by a dry process and thus omitting complex solvent removal and trapping processes but also is downsizable due to a thinner positive electrode material layer or negative electrode material layer.

Effects of the present disclosure are not limited to the effects mentioned hereinabove, and other effects not mentioned will be clearly understood by those skilled in the art from the following description.

### BRIEF DESCRIPTION OF THE DRAWINGS

FIG. 1 is a graph showing capacity retention as a function of the number of charge and discharge cycles for an electrode manufactured using Comparative Electrode Material Layer Composition 1 including polytetrafluoroethylene (PTFE) particles serving as a binder for an existing dry process, according to Comparative Example 1 of the present disclosure.

FIG. 2 is a graph showing capacity retention as a function of the number of charge and discharge cycles for an electrode made of Electrode Material Layer Composition 1 for a dry process, according to one example of the present disclosure, and an electrode made of Comparative Electrode Material Layer Composition 2 according to Comparative Example 2.

FIG. 3 is a graph showing capacity retention as a function of the number of charge and discharge cycles for an electrode made of Electrode Material Layer Composition 2 for a dry process, according to another example of the present disclosure.

FIG. 4 is a graph showing capacity retention as a function of the number of charge and discharge cycles for an electrode made of Electrode Material Layer Composition 3 for a dry process, according to a further example of the present disclosure.

FIG. 5 is a graph showing capacity retention as a function of the number of charge and discharge cycles for an electrode made of Electrode Material Layer Composition 4 for a dry process, according to yet another example of the present disclosure.

FIG. 6 is a graph showing specific capacity as a function of the number of charge and discharge cycles for an electrode made of Electrode Material Layer Composition 5 for a dry process, according to yet another example of the present disclosure.

### DETAILED DESCRIPTION

Although the terms used in the present disclosure are selected from currently available terms that are generally and widely used with consideration of function in the present disclosure, terms used herein may vary depending on the intention of operators working in this field, precedents, appearance of novel technology, or the like. Additionally, in specific cases, terms are selected by the applicant at his or her discretion, and the meanings of such terms will be specified in detail in the present disclosure in the corresponding cases.

When terms such as “including”, “having”, and “comprising” are mentioned and used in the present disclosure, other parts may be added unless these terms are used with “only”. When a component is expressed in the singular form, the singular form includes the plural form unless there are particularly explicit details.

In interpreting a component, even in the absence of a separately explicit description, the interpretation takes into account the margin of error.

The respective features of various embodiments of the present disclosure can be partially or entirely coupled to or combined with each other and can be variously inter-operated and driven technically. In addition, each of the embodiments can be performed independently from another or can be performed in conjunction in a correlated relationship.

Hereinafter, the technical configurations of the present disclosure will be described in detail with reference to the attached drawings and preferred embodiments.

However, the present disclosure is not limited to the embodiments described below and may be embodied in other forms. Throughout this specification, like reference numerals used to describe the present disclosure identify like components.

The technical feature of the present disclosure, which aims to provide a new use of an acrylate-based compound that is liquid at room temperature and is post-curable, lies in an electrode material layer composition including an acrylate-based compound as a novel binder so that an active material is uniformly kneaded using a binder that is liquid at room temperature, rather than using solid particles, when manufacturing an electrode by a dry process not involving the use of any solvent and a lithium-ion battery electrode including a positive electrode material layer or a negative electrode material layer made of the aforementioned composition, as well as a method of manufacturing an electrode, wherein an acrylate-based compound, serving as a novel binder for a dry process, enables the use of a uniformly kneaded electrode material layer composition, so a thinner positive electrode material layer or negative electrode material layer can be manufactured at low pressure, acrylate not only is solidified through post-curing of the acrylate-based compound included in a sheet after attaching such a manufactured positive electrode material layer sheet or negative electrode material layer sheet to an electrode plate to play a binder role but also enables the sheet to be well-attached to the electrode plate, and a rolling process is performed to increase the electrode density, and a lithium-ion battery including the aforementioned electrode.

In other words, as known in the art, an electrode, which is one of the important components constituting a lithium-ion battery, is manufactured by kneading a positive electrode active material or a negative electrode active material, an additive, and the like in conjunction with a binder to prepare an electrode material layer composition, fabricating the electrode material layer composition into an electrode material layer composition sheet having a desired thickness, and attaching the electrode material layer composition sheet onto a metal electrode plate again. However, when preparing such an electrode material layer composition, the components thereof are introduced into a solvent and kneaded in a wet process, making uniform kneading of individual components possible, while in a dry process, a solid binder must be used alone without any solvent, making it challenging to obtain a uniformly kneaded form. For this reason, the present disclosure has developed a newly formulated electrode material layer composition for a dry process, the electrode material layer composition including a novel binder for a dry process, which enables further uniform kneading, by using an acrylate-based compound that is present as a liquid at room temperature without involving the use of any solid binder as in the art but can be solidified through a separate treatment process, order to obtain an electrode material layer composition having a further uniformly kneaded form.

As a result, the technology of the present disclosure lies in a new use of an acrylate-based compound that is liquid at room temperature and is post-curable and, in other words, aims to provide a novel binder that can help not only obtain a further uniformly kneaded form when kneading active materials and additives but also form an electrode material layer. Thus, although the following description of the present disclosure is to be explained primarily using a positive electrode, it is apparent that this technology is commonly applicable regardless of the type of active material, that is, to a positive or negative electrode active material.

Accordingly, the present disclosure provides an electrode material layer composition for dry processing, the electrode material layer composition including a positive or negative electrode active material, an acrylate-based compound, and a curing agent for the acrylate-based compound.

In this case, the acrylate-based compound is not limited as long as it is present as a liquid at room temperature but is characterized by being solidified through a separate treatment process, which is a curing process. This is because when adding an appropriate type of curing agent to the acrylate-based compound that is present as a liquid at room temperature for curing under proper conditions, the acrylate compound is kept from being eluted in an electrolyte due to being converted into a solid polymer having a three-dimensional network structure and thus is characterized by not adversely affecting battery performance. Furthermore, in the case of an acrylate-based compound having appropriate functional groups, a polymer having a three-dimensional network structure is formed after curing and thus can increase the adhesion to a metal electrode plate, which is advantageous. In the meantime, although the examples below have been explained primarily using the acrylate-based compound (acrylates), it is apparent that methacrylate-based compounds having similar properties are included. Accordingly, it should be understood that the acrylate-based compound used in the present disclosure includes acrylate-based compounds and methacrylate-based compounds, as well as isostructural compounds having other substituents.

In this case, while the acrylate-based compound is not limited as long as it is an acrylate-based compound containing at least two or more functional groups, the functional group contained is not limited as long as it can be reacted by heat or light. the functional group may be one or more selected from the group consisting of methylene, a urethane group, an ester group, an ether group, an oxide group, an ethyleneoxide group, propyleneoxide group, an ethyleneglycol group, a propyleneglycol group, a butadiene group, an imide group, an amine group, an amide group, an epoxy group, an olefin group, a sulfone group, and a combination thereof. In particular, the acrylate-based compound may contain 2 to 16 functional groups. This is because when there are two or fewer functional groups, the acrylate is monofunctional making curing reactions challenging to occur, which is disadvantageous, while when there are 16 or more functional groups, there is a concern that the acrylate may be converted into a polymer having solid properties in a short period due to an excessively large number of functional groups, which is rather disadvantageous.

In addition, the acrylate-based compound used in the present disclosure refers to any type of acrylate compounds in the form of monomers, oligomers, and the like, unless otherwise mentioned. In one embodiment, the acrylate-based compound may be present in the form of monomers or oligomers whose main chain has 2 to 1,000 carbon atoms. This is because when the main chain has less than 2 carbon atoms, the acrylate-based compound becomes a highly brittle polymer during post-curing, making the use thereof as a binder material inappropriate, which is disadvantageous, while when the main chain has 1,000 or more carbon atoms, there is a concern that steric hindrance occurs and rather hinders the role of the acrylate-based compound as a binder. The main technical feature of the present disclosure is to use the acrylate-based compound, which is liquid at room temperature and is post-cured through separate treatment, as a binder. Thus, it is apparent that the aforementioned functional groups are only one of the examples thereof, and the present disclosure is not limited thereto.

The acrylate-based compound used in the present disclosure may be one or more selected from the group consisting of all types of aliphatic and aromatic acrylate-based monomers, such as triethyleneglycolacrylate, trimethylpropanetriacrylate, dipentaerythritolhexaacrylate, trimethylolpropanetrimethacrylate, and bisphenol A ethyleneoxidedimethacrylate, and oligomers, which are complexes formed of two or more monomer units whose main chain constitutes the foregoing acrylates, for example, methylene, a urethane group, an ester group, an ether group, an oxide group, an ethyleneoxide group, a propyleneoxide group, an ethyleneglycol group, a propyleneglycol group, a butadiene group, an imide group, an amine group, an amide group, an epoxy group, an olefin group, a sulfone group, and the like.

The acrylate-based compound may be included in an amount range of 0.1 to 20 parts by weight per 100 parts by weight of the positive or negative electrode active material. When the content of the acrylate-based compound is less than 0.1 parts by weight, the content of the acrylate-based compound is excessively low to play a binder role, which is disadvantageous in terms of kneading. When the content of the acrylate-based compound is 20 parts by weight or more, the content of the active material becomes relatively low, so the electric capacity compared to the total volume is reduced. As a result, there may be a problem that lithium-ion battery performance deteriorates.

As an acrylate-based curing agent, which is configured to convert the acrylate-based compound that is liquid at room temperature into a polymer having a three-dimensional network structure by curing through separate treatment after kneading, one or more of a heat-curing agent and a photocuring agent may be used. In other words, this is because when photocuring does not occur well, especially when an electrode layer is thick, the use of the photocuring agent (photoinitiator) and the heat-curing agent in combination may be further effective. As these curing agents, any material may be used regardless of the type as long as it generates radicals by heat or light.

More specifically, the heat-curing agent (thermal initiator), which is a curing agent including a peroxide or an azo compound, is not particularly limited in type as long as it is decomposed at a temperature in the range of 50° C. to 180° C. to generate a reaction initiator. In one embodiment, examples of the peroxide-containing curing agent (peroxide initiator) may include oxygen radical-generating benzoylperoxide (BP) and the like. In addition, as the azo compound-containing curing agent, 2, 2-azobisisobutyronitrile (AIBN) and the like may be used. In this case, when the decomposition temperature of the curing agent is lower than 50° C., the decomposition temperature is excessively low, so reaction initiators are generated readily, which is disadvantageous. When the decomposition temperature is 180° C. or higher, the temperature for the curing reaction to occur is excessively high, which is disadvantageous in terms of costs. Preferably, the use of a curing agent that is decomposed at a temperature in the range of 50° C. to 150° C. is desirable.

As the photocuring agent (photoinitiator), a phosphineoxide-based compound or a phenylketone-based compound generating radicals when irradiated with light, such as UV light, may be used. In one embodiment, solid and liquid photocuring agents represented as hydroxycyclohexylphenylketone, hydroxydimethylacetophenone, trimethylbenzoyldiphenylphosphineoxide, methylbenzoylformate, or the like may be used.

The curing agent may be included in an amount range of 0.1 to 20 parts by weight per 100 parts by weight of the acrylate-based compound. This is because when the content of the curing agent is less than 0.1 parts by weight, the acrylate-based compound fails to be cured and is highly likely to remain as a liquid even after the curing reaction, which is disadvantageous, while when the content of the curing agent exceeds 20 parts by weight, the acrylate-based compound is overly cured and thus becomes excessively firm, or there may be a concern that radicals resulting from the curing agent that has failed to fully participate in the curing reaction cause a side reaction and deteriorate a binder to be further included.

In addition to the acrylate-based compound, one or more binders that differ from the acrylate-based compound in type may be further included as needed. In this case, the acrylate-based compound and the binder may have a weight ratio in the range of 99:1 to 1:99. Preferably, the weight ratio of the acrylate-based compound to the binder is in the range of 80:20 to 20:80. When the weight ratio exceeds the upper limit or falls short of the lower limit, the resulting mixed binder is practically no longer a mixture but may as well be a nearly single binder, so the role thereof as a mixed binder becomes insignificant, which is disadvantageous.

In this case, any known binders may be used as the different types of binder as long as they can be used for the dry process, which may be used in combination of two or more binders. In one embodiment, the binder may include polytetrafluoroethylene (PTFE), polyolefin, polyalkylene, polyether, styrene-butadiene rubber (SBR), polysiloxane and copolymers thereof, branched-chain polyether, polyvinylether, polyacrylic acid, polyvinylcarbonate, copolymers thereof, and/or mixtures thereof. The one or more binders may further include guar, alginic acid, poly[(isobutylene-alt-maleic acid, ammonium salt)-co-isobutylene-alt-maleic anhydride)], poly(ethylene-alt-maleic anhydride), poly(methylvinylether-alt-maleic anhydride), polyacrylonitrile (PAN), poly(methylmethacrylate) (PMMA) , poly(vinyl chloride) (PVC), and polyvinylether. The binder may include cellulose. In some aspects, the polyolefin may include polyethylene (PE), polypropylene (PP), polyvinylidene fluoride (PVDF), copolymers thereof, and/or mixtures thereof. For example, the binder may include polyvinylidene chloride, poly(phenyleneoxide) (PPO), polyethylene-block-poly (ethyleneglycol), poly(ethyleneoxide) (PEO), polydimethylsiloxane (PDMS), PDMS-co-alkylmethylsiloxane, copolymers thereof, and/or mixtures thereof. In specific aspects, the binder capable of being fibrillated is PTFE. The binder may include cellulose or a cellulose derivative. The cellulose derivative may, for example, include: celluloseester, such as celluloseacetate; celluloseether, such as methylcellulose, ethylcellulose, hydroxypropylcellulose (HPC), hydroxylpropylmethylcellulose, or hydroxyethylcellulose (HEC); cellulose nitrate; cellulose chitosan, such as carboxymethylcellulosechitosan; or carboxyalkylcellulose, such as carboxymethylcellulose (CMC), carboxyethylcellulose, carboxypropylcellulose, or carboxyisopropylcellulose. In a further aspect, the cellulose or cellulose derivative may include a cellulose salt. In yet another aspect, cations of the cellulose salt may be selected from sodium, ammonium, calcium, or lithium. For example, the cellulose or cellulose derivative may include sodiumcellulose selected from sodiumcelluloseester, sodiumcelluloseether, sodiumcellulosenitrate, or sodiumcarboxyalkylcellulose, or a sodiumcellulose derivative. CMC may include sodiumcarboxymethylcellulose. In some aspects, the one or more binders include CMC, PVDF, and/or PTFE.

In some cases, the electrode material layer composition of the present disclosure may include a nanocarbon-based conductivity enhancer. The nanocarbon-based conductivity enhancer is not limited as long as it is a nano-sized carbon material. However, in one embodiment, the nanocarbon-based conductivity enhancer may be one or more selected from the group consisting of conductive carbon black, graphene, and carbon nanotubes (single-walled carbon nanotubes, double-walled carbon nanotubes, multi-walled carbon nanotubes, and the like). For example, carbon nanotubes are advantageous due to having significantly high aspect ratios. In the case of carbon nanotubes, while one or more types of single-walled, double-walled, and multi-walled carbon nanotubes may be used in combination, the content of the nanocarbon-based conductivity enhancer may be in the range of 0.05 to 300 parts by weight per 100 parts by weight of the acrylate-based compound or the acrylate-based compound and the different types of binder. When the content of the nanocarbon-based conductivity enhancer is less than 0.05 parts by weight, this content is excessively low, so the conductivity enhancement effect is insignificant, which is disadvantageous. When the content of the nanocarbon-based conductivity enhancer is 300 parts by weight or more, this content is excessively high, so there is a concern that the viscosity of the entire active material slurry becomes excessively high, or the density of the electrode layer made of the active material may be reduced, which is rather disadvantageous.

A method in which the conductivity enhancer such as carbon nanotubes or conductive carbon black is kneaded first in conjunction with the active material and the like and then finally kneaded with the addition of the liquid acrylate-based compound thereto may be used as a method of kneading the nanocarbon-based conductivity enhancer such as carbon nanotubes. Alternatively, the conductivity enhancer, such as carbon nanotubes or conductive carbon black, may be kneaded first with the acrylate-based compound and then kneaded again with the active material to prepare a final kneaded product.

The positive or negative electrode active material, which is suitable for use in a positive electrode or a negative electrode of a lithium-ion battery, may be any active material known in the art. In one embodiment, the positive or negative electrode active material may be one or more selected from the group consisting of lithium, manganese, nickel, cobalt, aluminum, iron, phosphorus, tin, titanium, a carbon material, silicon, silicon oxide, sulfur, and a combination thereof.

For example, the carbon material may be selected from a graphitic material, graphite, a graphene-containing material, hard carbon, soft carbon, carbon nanotubes, porous carbon, conductive carbon, or a combination thereof. The graphite may be either synthetically or naturally derived. Activated carbon may be derived either from a steam process or an acid/etching process. In some aspects, the graphitic material may be a surface-treated material. In some aspects, the porous carbon may include the activated carbon. In some aspects, the porous carbon may include hierarchically structured carbon. In some aspects, the porous carbon may include structured carbon nanotubes, structured carbon nanowires, and/or structured carbon nanosheets. In some aspects, the porous carbon may include a graphene sheet. In some aspects, the porous carbon may be surface-treated carbon.

In addition, a lithium-ion battery electrode of the present disclosure includes a positive electrode material layer or a negative electrode material layer made of any one of the aforementioned electrode material layer compositions for dry processing. The positive electrode material layer or the negative electrode material layer has a thickness of smaller than 100 μm. This is because as the electrode material layer composition for dry processing includes the acrylate-based compound, a thinner electrode film having excellent properties can be manufactured.

Furthermore, a method of manufacturing a lithium-ion battery electrode may include: a composition preparation step of preparing any one of the aforementioned electrode material layer compositions for dry processing; a sheet formation step of forming a positive electrode material layer sheet or a negative electrode material layer sheet using the electrode material layer composition for the dry process; an attachment step of attaching the positive electrode material layer sheet or the negative electrode material layer sheet to a metal electrode plate; a curing step of curing the attached positive electrode material layer sheet or negative electrode material layer sheet to obtain an electrode; and a step of rolling the electrode material layer obtained by performing the curing step. In this case, each of these steps may be processed in batches or performed through continuous processing to manufacture the final electrode plate. The most efficient manufacturing process is to introduce continuous processing.

In the composition preparation step, any known kneading methods may be used as long as all components, in other words, the negative or positive electrode active material, the liquid acrylate-based compound, and the curing agent for the acrylate-based compound, can be introduced and kneaded in a dry manner with the application of shear force. In this case, various kneading methods may be used. Examples of kneading machines may include kneaders in stirrer form (low-speed and high-speed stirrer), such as a Henschel mixer equipped with a blade in a proper form, or kneading machines in extruder form capable of continuous processing. Typically, kneading machines such as single-screw extruders with kneading functions, twin-screw extruders, or continuous kneaders are effective.

The sheet formation step may be performed by fabricating an active material composition sheet having a predetermined thickness using a die capable of fabricating a sheet form having an appropriate thickness at the end of such a continuous kneading machine and rolling the resulting active material composition sheet multiple times to achieve a desired thickness. In the examples and comparative examples to be described later, a calendaring method allowing the active material composition sheet to pass between two rolls designed to be spaced by a predetermined distance was used.

The attachment step performed may include: a step of forming a primer layer on the metal electrode plate; and a step of placing and compressing the positive electrode material layer sheet or the negative electrode material layer sheet onto the primer layer. In the continuous processing, the aforementioned attachment step may be performed on a metal electrode plate supplied through a separate supply device.

In the curing step, the positive electrode material layer sheet or the negative electrode material layer sheet attached to the metal electrode plate in the attachment step is cured so that the acrylate compound is solidified and plays a binder role. In addition, the curing step, which is a process to enhance the adhesion of the sheet to the metal electrode plate, may be performed by any one of photocuring through UV irradiation and heat curing to treat the attached positive electrode material layer sheet or negative electrode material layer sheet for 5 minutes to 30 minutes at a temperature in the range of 50° C. to 180° C.

The rolling step may be performed by finally pressing the electrode material layer, obtained by performing the curing step, with the application of an appropriate force to increase the electrode density.

### Example 1

Electrode Material Layer Composition 1 for dry processing was prepared by introducing 95.0 wt % of NCM811 serving as a positive electrode active material, 2.5 wt % of an acrylate-based compound (a mixture of bifunctional ethyleneglycol-based monomers and hexafunctional ethyleneglycol-based oligomers in a 1:1 weight ratio), 0.05 wt % of an azo-based curing agent (AIBN) serving as a heat-curing agent, 0.05 wt % of a phosphineoxide-based curing agent (trimethylbenzoyldiphenylphosphineoxide) serving as a photocuring agent, and 2.4 wt % of conductive carbon black into a kneader and then kneading the introduced materials at room temperature at 20 rpm for 10 minutes.

### Example 2

Electrode Material Layer Composition 2 for dry processing was prepared in the same manner as in Example 1, except for using 0.1 wt % of the azo-based curing agent (AIBN), serving as the heat-curing agent, without involving the use of the photocuring agent.

### Example 3

Electrode Material Layer Composition 3 for dry processing was prepared in the same manner as in Example 1, except for using a mixture of the acrylate-based compound and PTFE in a 1:1 weight ratio rather than using the acrylate-based compound.

### Example 4

Electrode Material Layer Composition 4 for dry processing was prepared in the same manner as in Example 1, except for using a mixture of the acrylate-based compound and ethyleneglycol-based copolymers (ethyleneglycol-maleic anhydride-acrylonitrile terpolymer, C&P Solutions, South Korea) in a 1:1 weight ratio rather than using the acrylate-based compound.

Example 5

Electrode Material Layer Composition 5 for dry processing was prepared by introducing 95.0 wts of a mixed active material of silicon oxide (SiOx) and graphite serving as a negative electrode active material (graphite: SiOx=90:10 (weight ratio), theoretical capacity: 470 mAh/g), 3.5 wt % hexafunctional urethane-based oligomers, 0.05 wt % of an azo-based curing agent (AIBN) serving as a heat-curing agent, 0.05 wt % of a phosphineoxide-based curing agent (trimethylbenzoyldiphenylphosphineoxide) serving as a photocuring agent, 1.4 wt % of carbon black, and 0.5 wt % of single-walled carbon nanotubes into a kneader and then kneading the introduced materials at room temperature at 20 rpm for 10 minutes.

### Example 6

### 1. Composition Preparation Step

Electrode Material Layer Composition 1 was prepared in the same manner as Example 1.

### 2. Positive Electrode Material Layer Sheet Formation Step

Electrode Material Layer Composition 1 was rolled multiple times while applying a pressure of 7 kgf/cm 2 , thereby forming a 70 μm-thick positive electrode material layer sheet.

3. Attachment step

### \textcircled{1} Primer Layer Formation Step

To attach the positive electrode material layer sheet onto an aluminum electrode plate, a primer layer was formed on the surface of the electrode plate, as follows. As a primer for a positive electrode plate, a primer solution was prepared by introducing carbon nanotubes into N-methyl-2-pyrrolidone (NMP) in conjunction with ethyleneglycol-maleic anhydride-acrylonitrile copolymers (C&P Solutions, South Korea), stirred the introduced materials at room temperature for 10 minutes, and then spraying the resulting product by a pressure spray method again. The content of the carbon nanotubes in the binder was 20 wt % with respect to the total weight of the copolymers, and the solid content in the dispersion was 4 wt %. The primer layer was formed to be about 1.0 μm-thick using a bar coater (drying: 130° C., 2 minutes). The test result using a tape on the primer layer confirmed that the primer layer was well-attached without being detached from the electrode plate. In addition, the surface resistance of the electrode plate on which the primer layer was formed was 2×10⁻³ ohm/area, which was similar to that of the aluminum electrode plate.

### \textcircled{2} Compression Step

The positive electrode material layer sheet was placed on the aluminum electrode plate on which the primer layer was formed and compressed to form a temporary positive electrode.

### 4. Curing Step

The temporary positive electrode was treated at a temperature of 120° C. for 10 minutes and then subjected to UV irradiation (700 mJ/cm²), thereby curing the bifunctional ethyleneglycol-based monomers and hexafunctional ethyleneglycol-based oligomers, serving as the acrylate-based compound. As a result, the acrylate compound used as the binder was allowed to play a binder role that was kept from being eluted in an electrolyte.

### 5. Rolling Step

The electrode material layer composition subjected to the curing step was subjected to a rolling process so that the electrode density became 1.0 g/cm³ . As a result, a positive electrode 1 for a lithium-ion battery, including the 70 μm-thick positive electrode material layer sheet, was finally manufactured.

### Example 7

Positive Electrode 2 for a lithium-ion battery, including a 70 μm-thick positive electrode material layer sheet, was manufactured by performing the same method as in Example 6, except for preparing Electrode Material Layer Composition 2 in the composition preparation step and performing heat curing (120° C., 10 minutes) alone without involving UV irradiation in the curing step.

### Example 8

Positive Electrode 3 for a lithium-ion battery, including a 75 μm-thick positive electrode material layer sheet, was manufactured by performing the same method as in Example 6, except for preparing Electrode Material Layer Composition 3 in the composition preparation step and applying a rolling pressure of 7 kgf/cm2 to form the electrode material layer sheet.

### Example 9

A negative electrode for a lithium-ion battery, including a 65 μm-thick negative electrode material layer sheet, was manufactured by performing the same method as in Example 6, except for preparing Electrode Material Layer Composition 5 in the composition preparation step, applying a rolling pressure of 7 kgf/cm2 in the sheet formation step to form the negative electrode material layer sheet, and using a copper foil as the metal electrode plate in the attachment step.

### Comparative Example 1

Comparative Electrode Material Layer Composition 1 was prepared by mixing 95.0 wt % of NCM811 serving as a positive electrode active material, 3.5 wt % of PTFE, and 1.5 wt % of conductive carbon black and stirring the resulting mixture at 300 rpm for 10 minutes.

### Comparative Example 2

Comparative Electrode Material Layer Composition 2 was prepared in the same manner as in Example 1, except for using 0.001 wt % of the azo-based curing agent (AIBN), 0.001 wt % of the phosphineoxide-based curing agent (trimethylbenzoyldiphenylphosphineoxide), and 2.498 wt % of conductive carbon black in a composition preparation step.

### Comparative Example 3

Comparative Positive Electrode 1 was manufactured by performing the same method as in Example 6, except for preparing Comparative Electrode Material Layer Composition 1 in the composition preparation step, applying a rolling pressure of 20 kgf/cm2 in the sheet formation step to form the positive electrode material layer sheet, and not performing the curing step. The thickness of the positive electrode material layer sheet formed when manufacturing Comparative Positive Electrode 1 is 110 μm.

### Comparative Example 4

Comparative Positive Electrode 2, including an 80 μm-thick positive electrode material layer sheet, was manufactured by performing the same method as in Example 6, except for preparing Comparative Electrode Material Layer Composition 2 in the composition preparation step.

### Experimental Example 1

Adhesion tests using Scotch tape were performed on Positive Electrodes 1 to 5 for the lithium-ion batteries and Comparative Positive Electrodes 1 and 2 to confirm whether the electrode material layer was well-attached to the metal electrode plate. To this end, the degree of adhesion was determined by whether the electrode material layer was detached from the electrode plate in the process of attaching 3M Scotch Tape to the surface of the electrode material layer and then removing the attached tape.

The adhesion test results using Scotch tape confirmed that all the electrode material layers of Positive Electrodes 1 to 5 for the lithium-ion batteries and Comparative Positive Electrode 1 were well-attached onto the electrode plate. However, in the case of Comparative Positive Electrode 2, the active material layer attached to the positive electrode plate was not firm, and in particular, the surface thereof remained sticky.

In other words, the electrode material layer of Positive Electrode 1 for the lithium-ion battery was well-attached to the electrode plate and was flexible, and the surface thereof was not sticky. In particular, the processability of the positive electrode material layer sheet was outstanding. The acrylate-based compound is liquid at room temperature, so processing, such as kneading and rolling of the active material composition made primarily of inorganic particles, is presumed to be much easier.

In the case of Positive Electrode 2 for the lithium-ion battery, the surface of the electrode material layer was also not sticky. Although the electrode material layer was well-attached to the electrode plate and was relatively flexible, the observation on the firmness showed that this electrode material layer was slightly less firm than that of Example 1 (the case where both the heat-curing agent and photocuring agent are used).

In the case of Positive Electrode 3 for the lithium-ion battery, the electrode material layer was firmly attached to the electrode plate and was flexible when the electrode plate bent. In addition, the surface thereof was not sticky.

In the case of Positive Electrode 4 for the lithium-ion battery, the active material composition sheet was easily fabricated into a 70 micron-thick sheet, and the adhesion thereof to the electrode plate was excellent. In addition, a firm electrode material layer was obtained.

The negative electrode for the lithium-ion battery also showed flexible bending characteristics, and the adhesion test result for this electrode material layer confirmed that the electrode material layer was well-attached to the electrode plate.

### Experimental Example 2

Experiments to measure and compare the pressure applied in the process of forming the electrode material layer and the final thickness formed were conducted on Positive Electrodes 1 to 5 for the lithium-ion batteries and Comparative Positive Electrodes 1 and 2.

The experiment results confirmed that when using the solid binder (PTFE) alone in the electrode material layer composition (Comparative Example 1), high-pressure rolling is required to form the positive electrode material layer sheet in the sheet formation step, and despite being rolled at even higher pressure, forming a positive electrode material layer sheet having a thickness of 100 microns or smaller was not easy. On the other hand, when the electrode material layer composition includes the acrylate-based compound, as in Examples 1 to 5 and Comparative Example 2, the rolling pressure required to form the positive electrode material layer sheet in the sheet formation step was also exceptionally low. In addition, it was confirmed that the positive electrode material layer sheet having a thickness of 100 μm or smaller (typically, 60 to 80 μm-thick) could be easily fabricated.

### Experimental Example 3

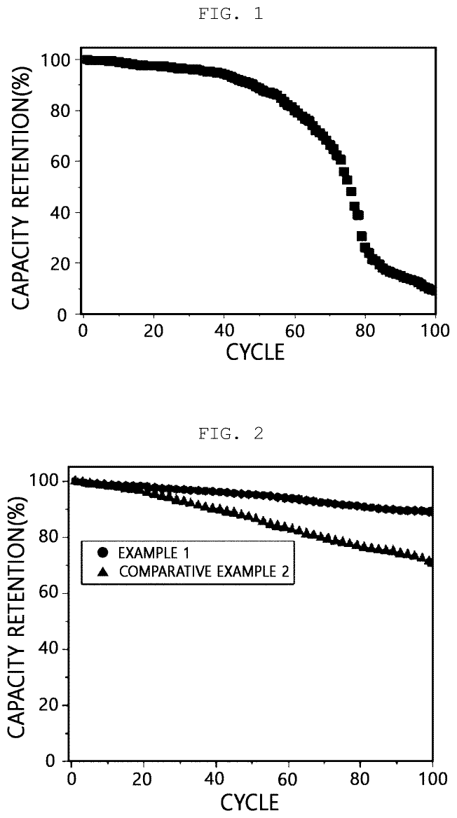

Charge and discharge cycle tests were conducted on Positive Electrodes 1 to 5 for the lithium-ion batteries and Comparative Positive Electrodes 1 and 2, as follows. FIGS. 1 to 6 show each of the test results.

Cell performance tests on the positive electrodes are conducted as follows. In the cell performance tests, a coin cell (CR2032) having a half-cell structure was fabricated, and a charge and discharge cycle test was conducted on the coin cell at a 1.0 C rate. In this case, a lithium metal foil was used as a counter electrode. As an electrolyte, an electrolyte solution prepared by dissolving 1.15 mol of LiPF, in a mixed solvent of carbonates, such as ethylenecarbonate (EC), propylenecarbonate (PC), diethylcarbonate (DEC), vinylenecarbonate (VC), and fluoroethylenecarbonate (FEC) (weight ratio: EC/DEC/VC/FEC=3/7/0.05/0.05), was used. The coin cell was manufactured in a glove box filled with argon gas.

In the charge and discharge cycle tests of the present disclosure, the initial rate increased from 0.1 C to 1.0 C, and then life tests were conducted at a 1.0 C rate. The discharge capacity after 4 cycles was determined as the initial capacity, and the initial capacity was compared with the discharge capacity after 50 to 100 cycles to calculate capacity retention.

As shown in FIG. 1, in the case of Comparative Positive Electrode 1, the result showed a decrease in capacity after about 40 to 50 cycles.

As a result of the charge and discharge cycle test on Positive Electrode 1 for the lithium-ion battery, according to Example 6 of the present disclosure, about 89% of the initial capacity was measured to be maintained after 100 cycles, as shown in FIG. 2. On the other hand, in the case of Comparative Positive Electrode 2, according to Comparative Example 4, the result showed that the capacity retention after 100 cycles was at about 70%, indicating a decrease in capacity. These results show that the acrylate-based compound is required to be sufficiently cured to play a binder role.

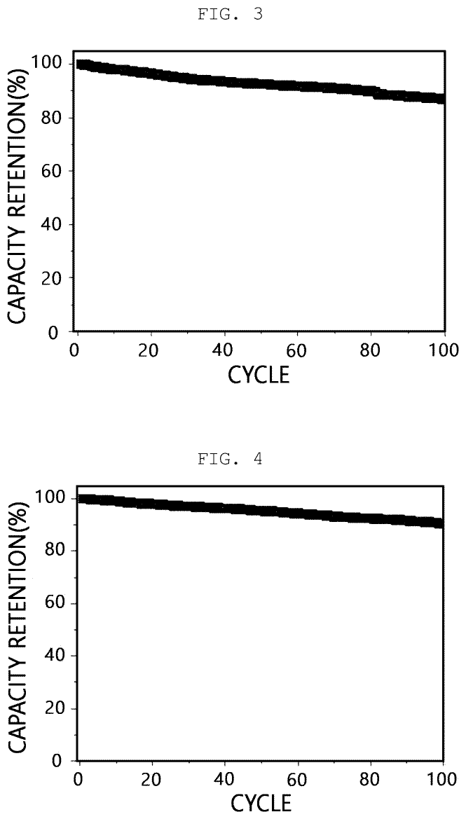

As shown in FIG. 3, the charge and discharge cycle test result of Positive Electrode 2 for the lithium-ion battery, according to Example 7 of the present disclosure, showed a slightly lower capacity retention at about 87% than the result of Example 1.

Referring to FIG. 4, showing the charge and discharge cycle test result of Positive Electrode 3 for the lithium-ion battery, according to Example 8 of the present disclosure, the capacity retention after 100 cycles was at about 90%, which was similar to the result of Positive Electrode 1 for the lithium-ion battery, according to Example 6. When comparing the results of Positive Electrode 3 for the lithium-ion battery of the present disclosure and Comparative Positive Electrode 1, it is seen that the use of PTFE and the acrylate-based binder of the present disclosure in combination improves a rapid decrease in capacity, which was observed when using PTFE alone.

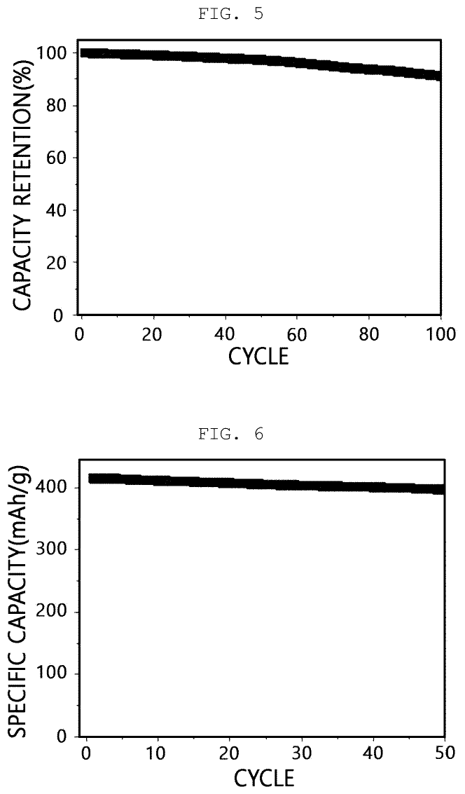

In addition, it is seen from FIG. 5, showing the charge and discharge cycle test result of Positive Electrode 4 for the lithium-ion battery, which is manufactured in the same manner as in Example 8 except that electrode material layer composition 4 was used of the present disclosure, that the capacity retention after 100 cycles was at about 91% meaning that the result obtained was excellent.

It is seen from the results of FIGS. 4 and 5 that the acrylate-based binder of the present disclosure can be used in combination with different binders for dry processes.

Referring to FIG. 6, showing the charge and discharge cycle test result of the negative electrode for the lithium-ion battery, according to Example 9 of the present disclosure, the capacity retention was at about 96% based on the measurement of the discharge capacity of 415 mAh/g after 4 cycles and the discharge capacity of 397 mAh/g after 50 cycles.

Thus, it was confirmed from the aforementioned experiment results that when using the acrylate-based compound as a binder in the electrode material layer composition for dry processing while using the curing agent for the acrylate-based compound in conjunction, the acrylate-based compound is liquid at room temperature, so the electrode material layer composition, including the positive or negative electrode active material, could be uniformly mixed. In addition, the processability of the electrode sheet made of the electrode material layer composition, that is, the positive electrode material layer sheet or the negative electrode material layer sheet, could also be excellent, so an electrode material layer composition sheet having a thickness of smaller than 100 microns, which is relatively thin, could be fabricated even at a relatively low pressure of less than 10 kgf/cm² . Furthermore, the adhesion of the electrode material layer sheet to the metal electrode plate could also be excellent through the final curing step, and the capacity retention could also be highly maintained during the charge and discharge cycle tests.

Therefore, when the electrode material layer composition for a dry process includes the acrylate-based compound as a binder and the curing agent for the acrylate-based compound, as in the present disclosure, the physical properties, as well as the capacity retention based on the cycle tests, are maintained at a significantly high level as long as the acrylate-based compound is cured regardless of curing methods, such as heat curing methods or photocuring methods. In particular, the use of the photoinitiator and the heat-curing agent in combination as the curing agent was confirmed to be highly effective in maintaining the physical properties of the electrode material layer.

The electrode material layer composition of the present disclosure not only can be used to form positive electrode material layers and negative electrode material layers but also can be variously used in typical lithium-ion batteries using active materials. In addition, the lithium-ion battery of the present disclosure can be used in devices using various batteries, such as electric vehicles, as well as mobile phones or laptops.

Although the present disclosure has been illustrated and described with the preferred embodiments as discussed hereinabove, the present disclosure is not limited to the aforementioned embodiments, and various changes and modifications can be made by those skilled in the art to which the present disclosure pertains, without departing from the spirit of the present disclosure.

1: An electrode material layer composition for a dry process, the electrode material layer composition comprising:
a positive or negative electrode active material;
an acrylate-based compound; and
a curing agent for the acrylate-based compound.

2: The electrode material layer composition of claim 1, wherein the acrylate-based compound comprises a methacrylate-based compound.

3: The electrode material layer composition of claim 1, wherein the acrylate-based compound comprises 2 to 16 functional groups and is a monomer or oligomer whose main chain has 2 to 1,000 carbon atoms.

4: The electrode material layer composition of claim 3, wherein the functional group ranges from 2 to 16 in number and is one or more selected from the group consisting of methylene, a urethane group, an ester group, an ether group, an oxide group, an ethyleneoxide group, a propyleneoxide group, an ethyleneglycol group, a propyleneglycol group, a butadiene group, an imide group, an amine group, an amide group, an epoxy group, an olefin group, a sulfone group, and a combination thereof.

5: The electrode material layer composition of claim 1, wherein the acrylate-based compound is comprised in an amount range of 0.1 to 20 parts by weight per 100 parts by weight of the positive or negative electrode active material.

6: The electrode material layer composition of claim 1, wherein the curing agent is one or more of a heat-curing agent and a photocuring agent and is comprised in an amount range of 0.1 to 20 parts by weight per 100 parts by weight of the acrylate-based compound.

7: The electrode material layer composition of claim 6, wherein the heat-curing agent comprises a peroxide or an azo compound, and the photocuring agent comprises a phenylketone-based compound or a phosphineoxide-based compound.

8: The electrode material layer composition of claim 1, further comprising:
one or more binders that differ from the acrylate-based compound in type.

9: The electrode material layer composition of claim 8, wherein the acrylate-based compound and the binder have a weight ratio in a range of 99:1 to 1:99.

10: The electrode material layer composition of claim 1, further comprising:
one or more nanocarbon-based conductivity enhancers comprising conductive carbon black, graphene, and carbon nanotubes.

11: The electrode material layer composition of claim 1, wherein the positive or negative electrode active material comprises one or more selected from the group consisting of lithium, manganese, nickel, cobalt, aluminum, iron, phosphorus, tin, titanium, a carbon material, silicon, silicon oxide, sulfur, and a combination thereof.

12: A lithium-ion battery electrode comprising one or more of a positive electrode material layer and a negative electrode material layer made of the electrode material layer composition of claim 1.

13: A method of manufacturing a lithium-ion battery electrode, the method comprising:
preparing the electrode material layer composition of claim 1;
forming a positive electrode material layer sheet or a negative electrode material layer sheet using the electrode material layer composition;
attaching the positive electrode material layer sheet or the negative electrode material layer sheet to a metal electrode plate;
curing the attached positive electrode material layer sheet or negative electrode material layer sheet to obtain an electrode; and
rolling the electrode material layer obtained by performing the curing.

14: The method of claim 13, wherein the attaching performed comprises:
forming a primer layer on the metal electrode plate; and
placing and compressing the positive electrode material layer sheet or the negative electrode material layer sheet onto the primer layer.

15: The method of claim 13, wherein the curing is performed by one or more of photocuring through ultraviolet (UV) irradiation and heat curing to treat the attached positive electrode material layer sheet or negative electrode material layer sheet for 5 minutes to minutes at a temperature in a range of 50° C. to 180° C.

16: A lithium-ion battery comprising the lithium-ion battery electrode of claim 12.

17: A lithium-ion battery comprising a lithium-ion battery electrode manufactured by the method of claim 13.

18: A lithium-ion battery electrode comprising one or more of a positive electrode material layer and a negative electrode material layer made of the electrode material layer composition of claim 5.

19: A lithium-ion battery electrode comprising one or more of a positive electrode material layer and a negative electrode material layer made of the electrode material layer composition of claim 6.

20: A lithium-ion battery electrode comprising one or more of a positive electrode material layer and a negative electrode material layer made of the electrode material layer composition of claim 8.
